(19) United States
(12) Patent Application Publication
(10) Pub. No.: US 2014/0233256 A1
(43) Pub. Date: Aug. 21, 2014

(54) Sunny Bright Solar Lighting

(71) Applicant: Loyd Edward Orfield, Colorado Springs, CO (US)

(72) Inventor: Loyd Edward Orfield, Colorado Springs, CO (US)

(21) Appl. No.: 13/770,346

(22) Filed: Feb. 19, 2013

(51) Int. Cl. F21S 19/00

(52) U.S. Cl. CPC F21S 19/005
USPC 362/555

(57) ABSTRACT

Sunny Bright Solar Lighting is an easily mounted roof solar sunpipe that magnifies and concentrates the incoming sun light with an internally mounted and focused nonimaging Fresnel lens paired with a Kohler concentrator lens in order to magnify and concentrate the focused intense sun light onto a fiber optic illumination systems glass plate, used for solid core fiber optic lighting cables, and a bundle of seven 14 mm solid core endglow plastic fiber optic cables that carries only light waves in a visible light spectrum to seven different rooms that are up to thirty three feet away from the roof mounted sunny bright solar tube. Each fiber optic cable has an easily installed adjustable light aperture with diffuser on the end in order to dim or turn off each light independently this would allow sunny bright solar lighting to bring the suns light into any desired room during the day and at night the 110v LED lighting array that is internally mounted in the sunny bright solar tube would replace the sunlight to continue lighting the seven different rooms.

### CROSS REFERENCES AND LINKS

The study of Evolutionary algorithm for optimization of nonimaging Fresnel lens geometry conducted by N. Yamada* and T. Nishikawa Department of Mechanical Engineering. Nagaoka University of Technology, Nagaoka 940-2188 Japan. *nobru@nagaokaut.ac.jp 2010 Optical Society of America OCIS: codes: 350.6050 Solar Energy; 220.1770 Concentrators; 220.4298 Nonimaging optics.

Patent application title: KOHLER CONCENTRATOR Inventors: Pablo Benitez Madrid, ES Juan Carlos Minano Madrid, ES Juan Carlos Minano Madrid, ES Juan Carlos Minano Madrid, ES Pablo Zamora Madrid, ES Maikel Hernandez Madrid, ES Aleksandra Cvetkovic Medrid, ES Assignees: Light Prescriptions Innovators, LLC IPC8 Class: AG02B2710FI USPC Class 359626 Class name Particular focusing or defocusing characteristic Publication Date: May 20, 2010 Patent application number: 201001.23954

United States Patent Application 20070159828. Kind Code A1. Wang; Robert Jul. 12, 2007. Description: Vertical LED lamp with a 360-degree radiation and a high cooling efficiency. Inventors: Wang; Robert; Taoyuan, TW Assignee: Ceramate Technical Co., Ltd. Serial No.: 327477 Series Code: 11 Filed: Jan. 9, 2006 Current U.S. Class: 362/294 Class at Publication: 362/294 International Class: F21V29/00 20060101 F21V029/00.

U.S. Pat. No. 6,201,915. Rizkin , et al. Mar. 13, 2001. Description: High efficiency lighting system having a remote light source. Inventors: Rizkin; Alexander Redondo Beach, Calif., Durets; Yevgeniy Long Beach, Calif., Rubtsov; Vladimir Los Angeles, Calif., Ruiz; David Redondo Beach, Calif., Tudhope; Robert H. Rancho Palos Verdes, Calif.. Assignee: Physical Optics Corporation Torrance, Calif.. application Ser. No.: 09/170,811. Filed: Oct. 13, 1998. Current U.S. Class: 385/115; 362/554; 362/583. Current International Class: G02B 6/25 20060101; G02B 6/42 20060101; G02B 6/40 20060101; F21V 8/00 20060101; G02B 006/04; F21V 008/00 . Field of Search: 385/115,901,54,116 362/84,218,551,554,556,583,217.

U.S. Pat. No. 5,980,075. Sheaffer Nov. 9, 1999. Description: Fiber optics illumination system for plastic light fiber. Inventors: sheaffer; Clifford G. Pittsburgh, Pa. application Ser. No. 09/031,161. Filed: Feb. 26, 1998. Current U.S. Class: 362/556; 362/307; 362/580; 385/115′ 385/901. Current International Class: F21V 8/00 20060101; G02B 6/40 20060101; G02B 6/42 20060101; F21V 008/00 ; G02B 006/04. Field of Search: 362/551,554,556,559,560,580,581,294,306,307, 385/52,115,116,119,120,123,901.

The Shenzhen Corpereal Photoelectric Co., Ltd. Plastic End solid core Fiber Optical light cable. http://corpereal.en.alibaba.com/

### DESCRIPTION

Sunny Bright Solar lighting is a new combination of proven existing technologies in a new way that will benefit any one that wants to illuminate a room or space with solar green energy lighting in the day and with an single 110v LED lighting array at night.

The energy saving Sunny Bright Solar lighting system would only cost to light the room or space during the night with the 110v LED lighting array in addition the Sunny Bright Solar Lighting system only requires 110v of electric supply to the single LED lighting array in the solar tube and not in the room or spaces the adjustable light diffusers are placed.

Sunny Bright Solar Lighting uses the proven Fresnel lens as the primary lens to magnify the incoming light in addition it uses N>Yamada* and T. Nishikawa study of the Evolutionary algorithm for optimization of nonimaging Fresnel lens geometry to further enhance all the sunlight from the omnidirectionol sunpipe and focuses it onto the Kohler concentrator to gather and optimize all the incoming light possible and concentrating it on to the glass plate of the fiber optics illumination system for plastic light fiber.

Sunny Bright Solar Lighting uses the proven technology of the High efficiency lighting and the fiber optic illumination system for plastic light fiber cables to bundle the seven 14 mm fiber optic cables together and provide the highest efficiency in illumination of the fiber optic cables possible in addition the high efficiency lighting system is designed to help dissipate any heat buildup.

Sunny Bright Solar Lighting system uses the technology of the solid core plastic fiber optic cable for its illumination ability to carry light waves in the visible light spectrum only it has a solid core with cladding and a buffer coating and comes in 100 ft rolls. Sunny Bright Solar Lighting divides the rolls into 33 ft long sections for minimal waste, at 33 ft the sunny bright system could span a distance of 60 ft easily and could easily come in different models for longer span distances sections could be up to 100 ft long.

Sunny Bright Solar Lighting system uses a fiber optic cable readymade light diffusers with an adjustable light aperture for ability to dim or turn off the incoming light from the Sunny Bright Solar Lighting system.

### BRIEF DESCRIPTION OF THE DRAWINGS:

FIG. 1. Shows a cross-sectional view; that shows the essential structure of the present invention The Sunny Bright Solar Lighting that is mounted in place on the roof.

FIG. 2. Shows a cross-sectional view; that shows the internally mounted 110v light emitting diode (LED) array in The Sunny Bright Solar Lighting tube.

FIG. 3. Shows a Top view; of the present invention The Sunny Bright Solar Lighting, showing it in use on a demonstration house with some possible light placement.

FIG. 4. Shows a cross- sectional and a top view; of the light diffuser with the adjustable light aperture.

FIG. 5. Shows a top view; that shows the bundle of seven plastic fiber optic cables with shielding.

FIG. 6. Shows a cross-sectional view; showing the Buffer Coating, Cladding, and Core of the solid plastic fiber optic cables:

FIG. 7. Shows a comparison; of the Skylight verse Sunpipe showing it ability of omnidirectional illumination and ease of installation and its low potential for leaks.

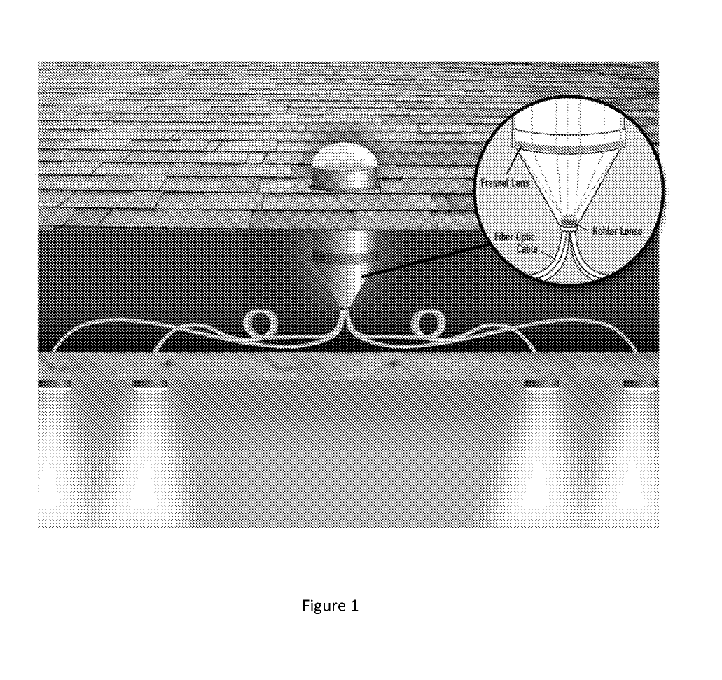

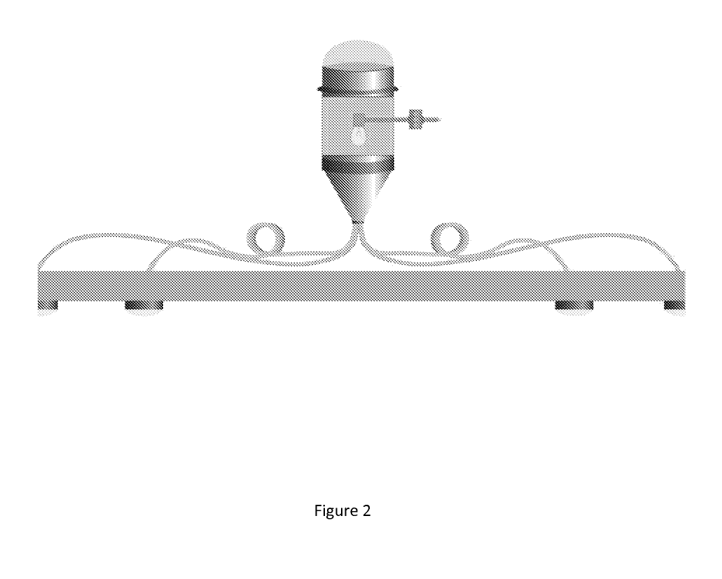

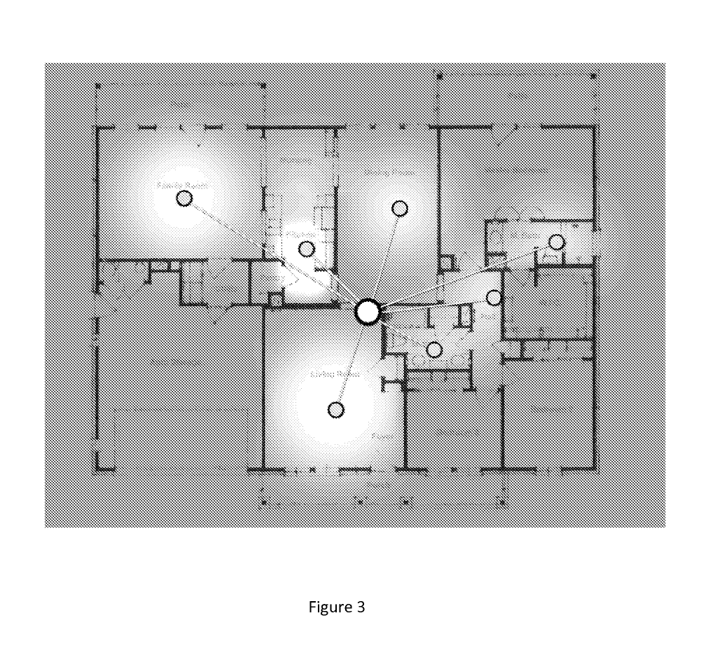

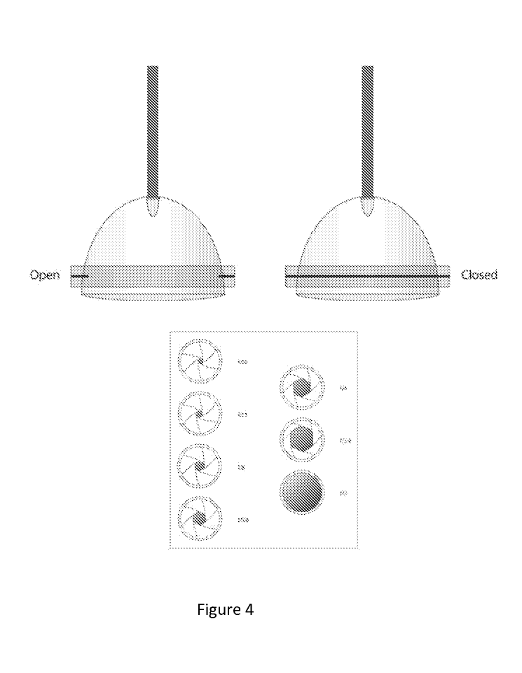

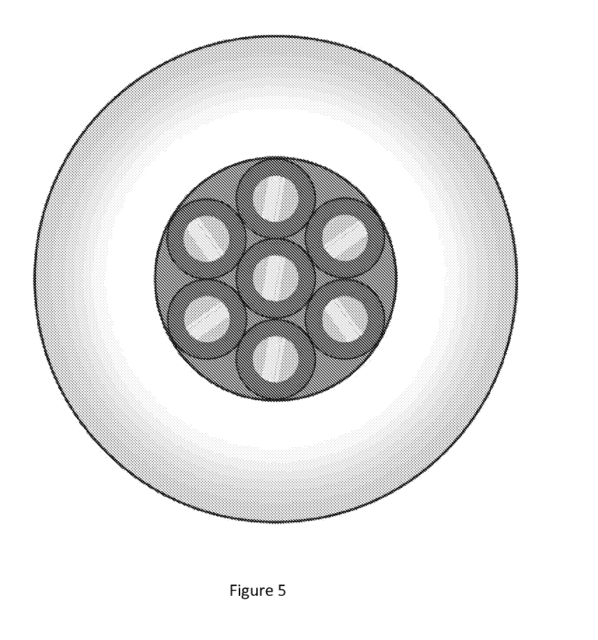

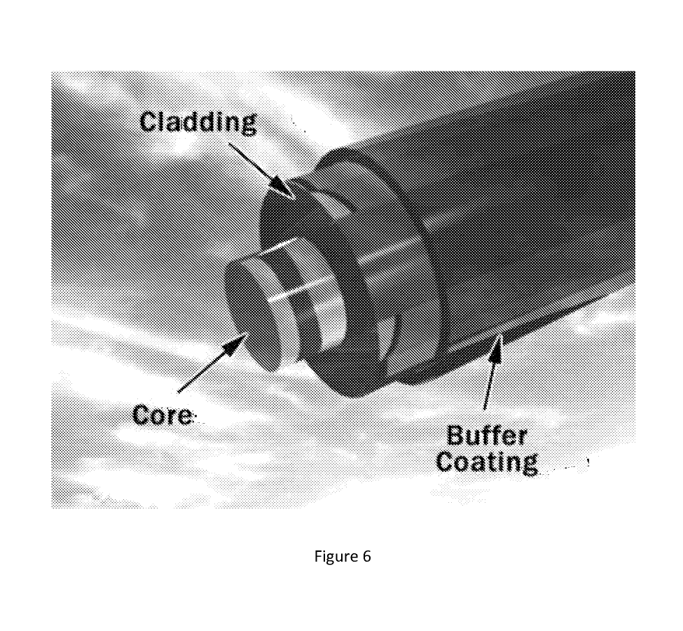

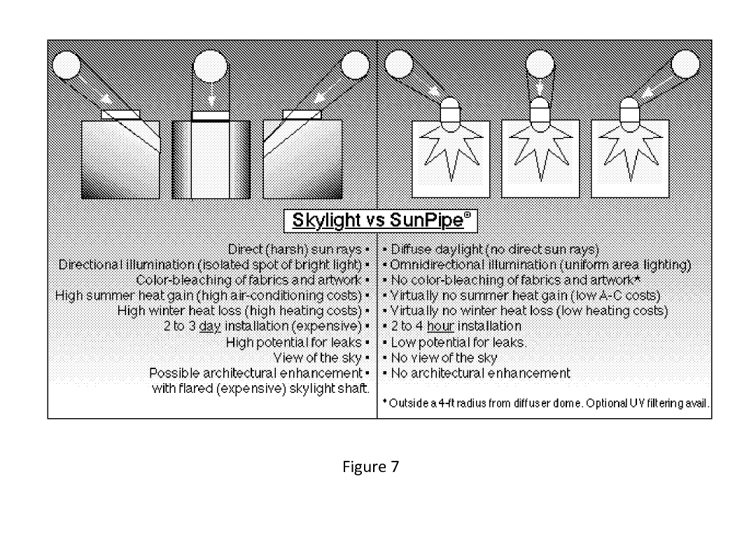

1. The present invention relates to the Sunny Bright Solar Lighting. A new green energy Lighting for any type of housing or industry uses any where indoor lighting is used. The invention combines portions of several existing technologies. Said system comprising: The technology of the sunpipe's easily roof mounted sky light with its ability to omnidirectional the sun's light thru out the day without having to track the sun; Reference: FIG. 7 Along with the 110v light emitting diode LED for night time use; Reference: 0003; FIG. 2 and with portions of the technology of evolutionary algorithm to design the optical geometry of the nonimaging Fresnel lens for uniform flux concentration required for photovoltaic cell uses; Reference: 0001; FIG. 1 Along with portions of the technology of a Kohler concentrator lens to form a Kohler integrator to concentrate and arrange the light onto a common target used mainly for photovoltaic cells. The present invention the Sunny Bright Solar Lighting system would not focuses the light form the Fresnel and Kohler lenses with their nonimaging and concentrating technology onto a photovoltaic cell for electricity;
Reference: 0001; 0002; FIG. 1 but onto the fiber optic illumination system and cables for the intense visible light spectrum that is produce. The new Sunny Bright Solar Lighting configuration would magnify and concentrate the sunpipe's light to its maximum amount of visible light spectrum possible with the minimal amount of heat possible; Thereby concentrating the light onto portions of the technology of; Reference: 0004; 0005; FIG. 5 fiber optics illumination system for plastic light fiber, and the seven 14 mm plastic end solid core fiber optical light cables; FIG. 5 that carries only light waves in the visible light spectrum. At the end of each fiber optic cable is a light diffuser with an adjustable light aperture; Reference: FIG. 4 in order to dim or turn off the Sunny Bright Solar Lighting that is installed in the ceiling of the desired room.
The present invention of claim 1, The sunpipe's ability to gather the sunlight without having to track the sun makes it perfect for Sunny Bright Solar Lighting; Reference: FIG. 7. With its omnidirectional illumination the sunpipe has the right geometry to produce the Constance rays of sunlight threw it, making the combining of the technologies of the; Reference: 0001; 0002; FIG. 7 nonimaging Fresnel lens with a Kohler concentrator and the sunpipe perfect; Reference: 0001; 0002; FIG. 1. No need for the nonimaging Fresnel lens to track the sun for the optimal sunlight needed, the sunlight would be Constance because of the sunpipe. The nonimaging Fresnel lens geometry along with the Kohler concentrator geometry could then be calculated for the maximum amount of visible light spectrum focused onto the; Reference: 0004; 0005 fiber optics illumination system for plastic light fiber, and the seven endglow solid plastic fiber optics ends for lighting the desired room.
The present invention of claim 1, The 110v light emitting diodes would be mounted inside the sunpipe to take the place of the sunlight at night; Reference: 0003; FIG. 2.
The present invention of claim 1, The Evolutionary algorithm for optimization of The nonimaging Fresnel lens with a Kohler concentrator technologies; Reference: 0001; 0002 has been used in the solar voltaic concentrator industry to produce electricity from sunlight by focusing and concentrating the sunlight onto a solar photovoltaic cell to produce the maximum amount of electricity possible. The Sunny Bright Solar Lighting system uses this optimization technology with a much larger nonimaging Fresnel lens and a Kohler concentrator; Reference: FIG. 1 for the intense sunlight that is produced using the Kohler integrators to arrange and direct light from a common source onto a common target the fiber optics illumination system for plastic light fiber; Reference: 0004; 0005; FIG. 5 and the Endglow solid plastic fiber optics cable to produce the maximum amount of visible light spectrum possible into the solid fiber optics cable; Reference: 0006; FIG. 6. The Sunny Bright Solar Lighting system can be easily installed in the desired room with the fiber optics cable and light diffuser with adjustable aperture up to 33 feet away from the Sunny Bright Solar lighting tube; Reference: FIG. 3; FIG. 4.
The present invention of clam 1, The technology of fiber optics illumination system for plastic light fiber; Reference: 0004; 0005 is presently used with high wattage electric lights and fiber optics for light displays. The Sunny Bright Solar Lighting uses the fiber optics illumination system; Reference: 0004; 0005; FIG. 5 for grouping the seven 14 mm solid Endglow plastic fiber optics cable together to focus the magnified incoming light from the Optic lenses onto the glass plat's and the ends of the Endglow solid plastic fiber optics cable for the best illumination possible; Reference: FIG. 5 and it will all so help to dissipate any heat problems.
The present invention of clam 1, The 14mm plastic end solid core fiber optical light cables is available and comes in 100 ft rolls that will only Carrie light waves in the visible light spectrum, and also available are a variety of fiber optic cable light diffusers for lighting rooms; Reference: 0006; FIG. 6.
